(19) United States
(12) Patent Application Publication
(10) Pub. No.: US 2026/0189035 A1
(43) Pub. Date: Jul. 2, 2026

(54) BATTERY SYSTEM

(71) Applicant: HONDA MOTOR CO., LTD., Tokyo (JP)

(72) Inventors: Soichi MORII, Saitama (JP); Yasushi Ogihara, Saitama (JP); Katsuya Shimazaki, Saitama (JP); Hideki Sakamoto, Saitama (JP)

(73) Assignee: HONDA MOTOR CO., LTD., Tokyo (JP)

(21) Appl. No.: 19/428,385

(22) Filed: Dec. 22, 2025

(30) Foreign Application Priority Data
Dec. 26, 2024 (JP) 2024-230316

(51) Int. Cl. H02J 7/50; B60L 58/19; H02J 7/00; H02J 7/94

(52) U.S. Cl. CPC H02J 7/575; B60L 58/19; H02J 7/855; H02J 7/94; H02J 2207/10

(57) ABSTRACT

A battery system has a battery and a switch drive mechanism. The battery includes power storage units, and a switch including a first switch and a second switch and switching between a first voltage state and a second voltage state. The switch drive mechanism includes a power supply and a switch drive circuit. The switch drive circuit connects the power supply and a positive electrode of the first switch, connects a negative electrode of the first switch and a negative electrode of the second switch, and connects a positive electrode of the second switch and the power supply. When the battery is in the first voltage state, the switch drive mechanism turns on the first switch and turns off the second switch. When the battery is in the second voltage state, the switch drive mechanism turns on the second switch and turns off the first switch.

### CROSS-REFERENCE TO RELATED APPLICATIONS

This application is based on and claims priority under 35 USC 119 from Japanese Patent Application No. 2024-230316 filed on December 26, 2024, the entire content of which is incorporated herein by reference.

### TECHNICAL FIELD

The present disclosure relates to a battery system.

### BACKGROUND ART

In recent years, in order to allow more users to access affordable, reliable, sustainable, and advanced energy, researches and developments have been conducted on charging and power feeding in a vehicle mounted with a secondary battery that contributes to an increase in energy efficiency.

Charging facilities having different charging voltages depending on charging stations are provided for charging and power feeding in the vehicle equipped with a secondary battery. For example, there are two types of charging facilities corresponding to 400V class and 800V class. When a vehicle is compatible with only the charging facility of 400V class, the vehicle cannot enjoy quick charging performance of the charging facility of 800V class by the charging facility of 800V class.

In a case where the vehicle is both compatible with the charging facilities of 400V class and 800V class, generally, a voltage is boosted to 800V by a voltage converter when charging by the charging facility of 400V class, or the voltage is stepped down to 400V by the voltage converter when charging by the charging facility of 800V class. However, when such a voltage converter for charging is used during charging, efficiency deteriorates.

In this regard, there is known a vehicle that switches a pattern of connecting battery modules such that charging can be performed by both a charging facility of 400V class and a charging facility of 800V class without using any voltage converter for charging (for example, see JP2024-052465A and JP2024-079278A).

Such a battery of the vehicle is provided with a series-connection switch that is turned on when the battery modules are in a series connection state and is turned off when the battery modules are in a parallel connection state, and a parallel-connection switch that is turned on when the battery modules are in a parallel connection state and is turned off when the battery modules are in a series connection state, and by appropriately switching these switches, efficient charging is possible even when the charging voltage is different.

However, in a case where the parallel-connection switch is unintentionally turned on when the battery modules are in the series connection state, or the series-connection switch is unintentionally turned on when the battery modules are in the parallel connection state, the battery may be short-circuited.

### SUMMARY OF INVENTION

The present disclosure provides a battery system allowing, by switching a pattern of connecting battery modules, charging even in cases of different charging voltages while preventing a short circuit of a battery.

An aspect of the present disclosure is a battery system having:

a battery including:

a first power storage unit;

a second power storage unit; and

a switch configured to switch between a first voltage state in which the first power storage unit and the second power storage unit are connected in series and are chargeable at a first voltage, and a second voltage state in which the first power storage unit and the second power storage unit are connected in parallel and are chargeable at a second voltage; and

a switch drive mechanism configured to drive the switch, in which the switch includes:

a first switch configured to be turned on when the battery is in the first voltage state, and turned off when the battery is in the second voltage state; and

a second switch configured to be turned on when the battery is in the second voltage state, and turned off when the battery is in the first voltage state,

the switch drive mechanism includes a power supply for driving the switch, and a switch drive circuit,

the switch drive circuit connects the power supply and a positive electrode of the first switch, connects a negative electrode of the first switch and a negative electrode of the second switch, and connects a positive electrode of the second switch and the power supply, and

the switch drive mechanism

when the battery is in the first voltage state, supplies the first switch with a current in a forward direction to turn on the first switch, and supplies the second switch with a current in a reverse direction to turn off the second switch, and

when the battery is in the second voltage state, supplies the second switch with a current in the forward direction to turn on the second switch, and supplies the first switch with a current in the reverse direction to turn off the first switch.

According to the aspect of the present disclosure, it is possible to provide the battery system allowing, by switching a pattern of connecting battery modules, charging even in cases of different charging voltages while preventing a short circuit of the battery.

### BRIEF DESCRIPTION OF DRAWINGS

Exemplary embodiment(s) of the present invention will be described in detail based on the following figures, wherein:

FIG. 1 is a diagram showing a battery 2;

FIG. 2 is a diagram showing a first voltage state (800V start-up) of the battery 2;

FIG. 3 is a diagram showing a second voltage state (400V start-up) of the battery 2;

FIG. 4 is a diagram showing a battery system 1;

FIG. 5 is a diagram showing a first drive state (800V start-up) of the battery system 1; and

FIG. 6 is a diagram showing a second drive state (400V start-up) of the battery system 1.

### DESCRIPTION OF EMBODIMENTS

Hereinafter, a battery system according to an embodiment of the present disclosure will be described with reference to the drawings.

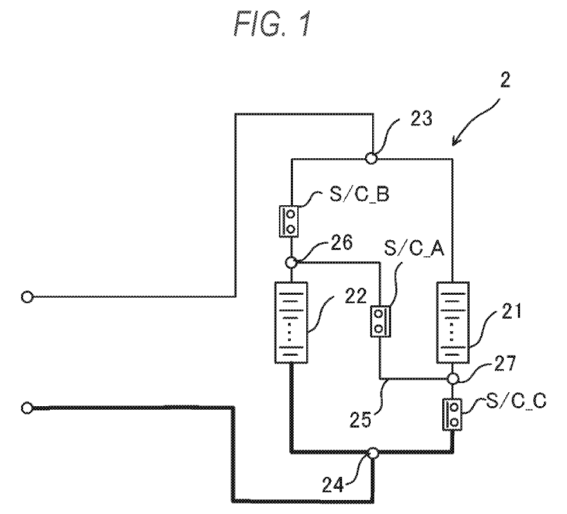

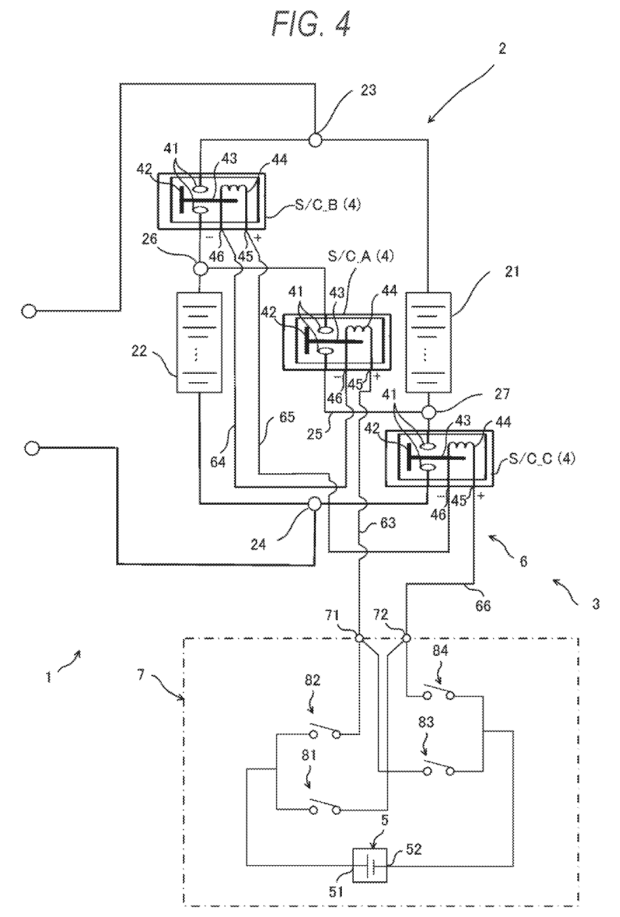

As shown in FIGS. 4 to 6, a battery system 1 of the present embodiment includes a battery 2 and a switch drive mechanism 3. First, the battery 2 will be described with reference to FIGS. 1 to 3.

### Battery

As shown in FIGS. 1 to 3, the battery 2 includes a first power storage unit 21, a second power storage unit 22, and first to third contactors S/C_A, S/C_B, and S/C_C.

The first power storage unit 21 and the second power storage unit 22 are battery modules that can perform charging and discharging of 400V.

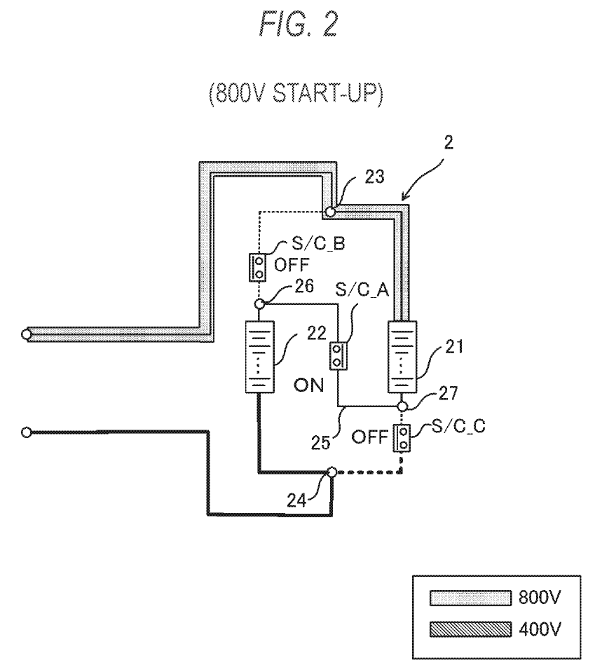

The first to third contactors S/C_A, S/C_B, and S/C_C switch a connection state between the first power storage unit 21 and the second power storage unit 22. For example, as shown in FIG. 2, when the first contactor S/C_A is turned on and the the second contactor S/C_B and the third contactor S/C_C are turned off, the battery 2 gets to a first voltage state (800V start-up), in which the first power storage unit 21 and the second power storage unit 22 are connected in series, and can be charged and discharged at 800V.

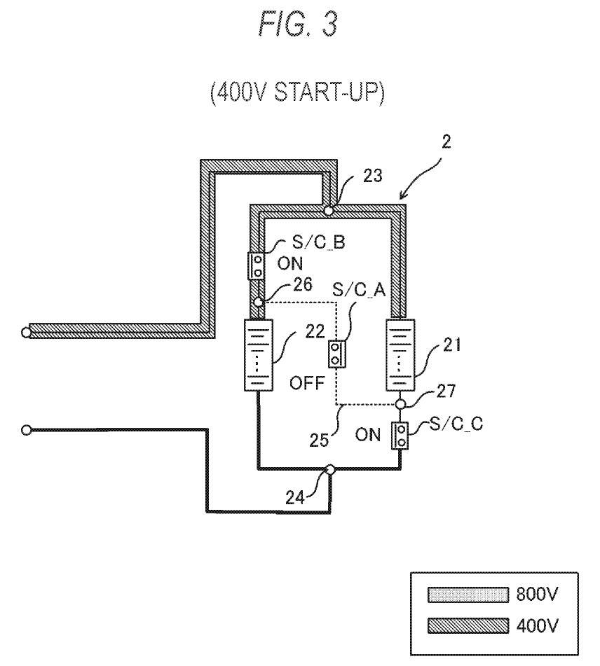

As shown in FIG. 3, when the first contactor S/C_A is turned off, and the second contactor S/C_B and the third contactor S/C_C are turned on, the battery 2 gets to a second voltage state (400V start-up), in which the first power storage unit 21 and the second power storage unit 22 are connected in parallel, and can be charged and discharged at 400V. The start-up refers to a concept including driving during traveling of the vehicle and charging during stopping of the vehicle.

Specifically, with reference to FIGS. 1 to 3, the battery 2 includes a positive node 23 that connects a positive terminal of the first power storage unit 21 and a positive terminal of the second power storage unit 22 in parallel, a negative node 24 that connects a negative terminal of the first power storage unit 21 and a negative terminal of the second power storage unit 22 in parallel, and a connection circuit 25 that connects the negative terminal of the first power storage unit 21 and the positive terminal of the second power storage unit 22. One end of the connection circuit 25 is connected to a circuit that connects the positive node 23 and the positive terminal of the second power storage unit 22 by a first connection part 26, and the other end of the connection circuit 25 is connected to a circuit that connects the negative node 24 and the negative terminal of the first power storage unit 21 by a second connection part 27. The first contactor S/C_A is provided in the connection circuit 25, the second contactor S/C_B is provided between the first connection part 26 and the positive node 23, and the third contactor S/C_C is provided between the second connection part 27 and the negative node 24.

### Switch Drive Mechanism

As shown in FIGS. 4 to 6, the switch drive mechanism 3 drives the first to third contactors S/C_A, S/C_B, and S/C_C. Each of contactors 4 constituting the first to third contactors S/C_A, S/C_B, and S/C_C includes a pair of fixed contacts 41, a movable contact 42 movable between an ON position in contact with the pair of fixed contacts 41 and an OFF position separated from the pair of fixed contacts 41, a movable iron core 43 moving integrally with the movable contact 42, a coil 44 moving the movable iron core 43 by a generated magnetic force, a positive electrode 45 to which one end of the coil 44 is connected, and a negative electrode 46 to which the other end of the coil 44 is connected.

In such a contactor 4, when a current in a forward direction (current flowing from the positive electrode 45 to the negative electrode 46) is supplied to the coil 44, the movable iron core 43 moves in a drawing direction by the magnetic force in the forward direction generated by the coil 44. Accordingly, the movable contact 42 moves to the ON position at which the movable contact 42 is in contact with the pair of fixed contacts 41, and the contactor 4 enters an on state (forced on state).

When a current in a reverse direction (current flowing from the negative electrode 46 to the positive electrode 45) is supplied to the coil 44, the movable iron core 43 moves in a push-out direction by the magnetic force in the reverse direction generated by the coil 44. Accordingly, the movable contact 42 moves to the OFF position at which the movable contact 42 is separated from the pair of fixed contacts 41, and the contactor 4 enters an off state (forced off state).

Further, in a state where no current is supplied to the coil 44, the movable iron core 43 moves in the push-out direction by a biasing force of a spring (not shown). Accordingly, the movable contact 42 moves to the OFF position at which the movable contact 42 is separated from the pair of fixed contacts 41, and the contactor 4 enters an off state (normal off state).

The switch drive mechanism 3 includes a power supply 5 and a switch drive circuit 6. The switch drive circuit 6 connects the power supply 5 and the positive electrode 45 of the first contactor S/C_A, and connects the negative electrode 46 of the first contactor S/C_A and the negative electrode 46 of the second contactor S/C_B, connects the positive electrode 45 of the second contactor S/C_B and the negative electrode 46 of the third contactor S/C_C, and connects the positive electrode 45 of the third contactor S/C_C and the power supply 5. That is, the switch drive circuit 6 connects the first contactor S/C_A, the second contactor S/C_B, and the third contactor S/C_C in series, and connects the negative electrode 46 of the first contactor S/C_A and the negative electrode 46 of the second contactor S/C_B or the negative electrode 46 of the third contactor S/C_C.

An order of the series connection can be changed as appropriate, the present invention is not limited to the case where the first contactor S/C_A, the second contactor S/C_B, and the third contactor S/C_C are connected in series in this order from the power supply 5 to the power supply 5 as in the present embodiment, and the second contactor S/C_B, the first contactor S/C_A, and the third contactor S/C_C may be connected in this order.

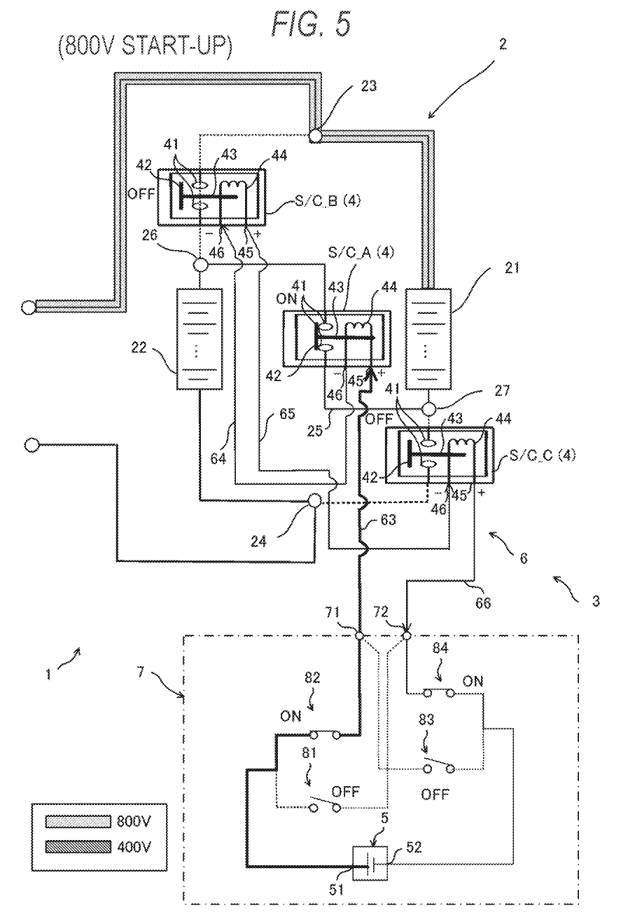

Then, as shown in FIG. 5, when the battery 2 is in the first voltage state (800V start-up), the switch drive mechanism 3 supplies the first contactor S/C_A with a current in the forward direction to turn on the first contactor S/C_A, and supplies the second contactor S/C_B and the third contactor S/C_C with a current in the reverse direction to turn off the second contactor S/C_B and the third contactor S/C_C.

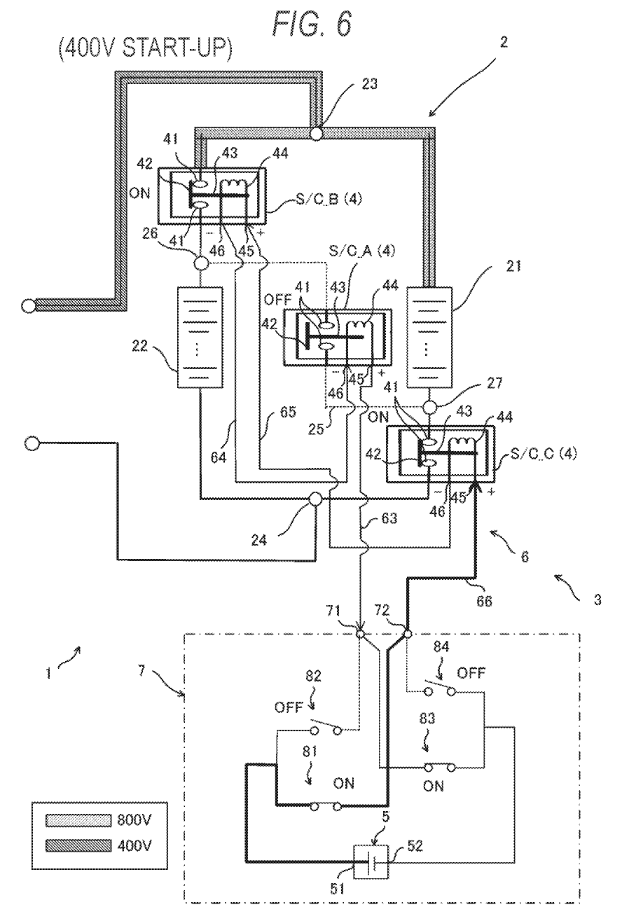

Further, as shown in FIG. 6, when the battery 2 is in the second voltage state (400V start-up), the switch drive mechanism 3 supplies the second contactor S/C_B and the third contactor S/C_C with a current in the forward direction to turn on the second contactor S/C_B and the third contactor S/C_C, and supplies the first contactor S/C_A with a current in the reverse direction to turn off the first contactor S/C_A.

According to such a switch drive mechanism 3, when the battery 2 is in the first voltage state (800V start-up), not only a current in the forward direction is supplied to the first contactor S/C_A to turn on the first contactor S/C_A, but also a current in the reverse direction is supplied to the second contactor S/C_B and the third contactor S/C_C to forcibly turn off the second contactor S/C_B and the third contactor S/C_C, so that a situation in which the second contactor S/C_B or the third contactor S/C_C are unexpectedly turned on can be avoided.

Further, when the battery 2 is in the second voltage state (400V start-up), the switch drive mechanism 3 not only supplies the second contactor S/C_B and the third contactor S/C_C with a current in the forward direction to turn on the second contactor S/C_B and the third contactor S/C_C, but also supplies the first contactor S/C_A with a current in the reverse direction to forcibly turn off the first contactor S/C_A, so that a situation in which the first contactor S/C_A is unexpectedly turned on can be avoided. Accordingly, short-circuiting of the battery 2 by unexpectedly turning on the first to third contactors S/C_A, S/C_B, and S/C_C can be avoided.

Specifically, the switch drive mechanism 3 of the present embodiment includes a control unit 7 and the switch drive circuit 6. The control unit 7 includes the power supply 5, a first pin 71 connected to one of a positive electrode 51 and a negative electrode 52 of the power supply 5, and a second pin 72 connected to the other of the positive electrode 51 and the negative electrode 52 of the power supply 5.

Further, the switch drive circuit 6 includes a first series circuit 63 that connects the first pin 71 and the positive electrode 45 of the first contactor S/C_A, a second series circuit 64 that connect the negative electrode 46 of the first contactor S/C_A and the negative electrode 46 of the second contactor S/C_B, a third series circuit 65 that connects the positive electrode 45 of the second contactor S/C_B and the negative electrode 46 of the third contactor S/C_C, and a fourth series circuit 66 that connects the positive electrode 45 of the third contactor S/C_C and the second pin 72. Accordingly, it is possible to cause currents to flow to the first to third contactors S/C_A, S/C_B, and S/C_C at the same time by one control unit 7.

The control unit 7 further includes first to fourth changeover switches 81 to 84. The first to fourth changeover switches 81 to 84 switch between a first drive state in which a current supplied from the power supply 5 is supplied from the first pin 71 to the switch drive circuit 6 and returned from the switch drive circuit 6 to the power supply 5 through the second pin 72, and a second drive state in which a current supplied from the power supply 5 is supplied from the second pin 72 to the switch drive circuit 6 and returned from the switch drive circuit 6 to the power supply 5 through the first pin 71.

The first to fourth changeover switches 81 to 84 are set to the first drive state when the battery 2 is in the first voltage state (800V start-up), and are set to the second drive state when the battery 2 is in the second voltage state (400V start-up). Accordingly, switching between the first voltage state (800V start-up) and the second voltage state (400V start-up) of the battery 2 can be realized by switching between the first drive state and the second drive state by the first to fourth changeover switches 81 to 84 of the control unit 7.

Specifically, the first changeover switch 81 is provided between the positive electrode 51 of the power supply 5 and the second pin 72, the second changeover switch 82 is provided between the positive electrode 51 of the power supply 5 and the first pin 71, the third changeover switch 83 is provided between the negative electrode 52 of the power supply 5 and the first pin 71, and the fourth changeover switch 84 is provided between the negative electrode 52 of the power supply 5 and the second pin 72.

When the first changeover switch 81 and the third changeover switch 83 are turned off and the second changeover switch 82 and the fourth changeover switch 84 are turned on as shown in FIG. 5, the first drive state is established, and when the first changeover switch 81 and the third changeover switch 83 are turned on and the second changeover switch 82 and the fourth changeover switch 84 are turned off as shown in FIG. 6, the second drive state is established.

In this way, according to the present embodiment, when the battery 2 is in the first voltage state (800V start-up), a current in the forward direction is supplied to the first contactor S/C_A to turn on the first contactor S/C_A and a current in the reverse direction is supplied to the second contactor S/C_B and the third contactor S/C_C to turn off the second contactor S/C_B and the third contactor S/C_C, and thereby a situation in which the second contactor S/C_B and the third contactor S/C_C are unexpectedly turned on can be avoided.

Similarly, when the battery 2 is in the second voltage state (400V start-up), a current in the forward direction is supplied to the second contactor S/C_B and the third contactor S/C_C to turn on the second contactor S/C_B and the third contactor S/C_C, and a current in the reverse direction is supplied to the first contactor S/C_A to turn off the first contactor S/C_A, and thereby a situation in which the first contactor S/C_A is unexpectedly turned on can be avoided. Accordingly, the short-circuiting of the battery 2 can be avoided.

Although the various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, constituent elements in the embodiment described above may be freely combined without departing from the gist of the present invention.

In the present specification, at least the following matters are described. In the parentheses, the corresponding constituent elements and the like in the above embodiment are shown, but the present invention is not limited thereto.

(1) A battery system (battery system 1) including:

a battery (battery 2) including:

a first power storage unit (first power storage unit 21);

a second power storage unit (second power storage unit 22); and

a switch (first to third contactors S/C_A, S/C_B and S/C_C) configured to switch between a first voltage state in which the first power storage unit and the second power storage unit are connected in series and are chargeable at a first voltage (800V), and a second voltage state in which the first power storage unit and the second power storage unit are connected in parallel and are chargeable at a second voltage (400V); and

a switch drive mechanism (switch drive mechanism 3) configured to drive the switch, in which

the switch includes:

a first switch (first contactor S/C_A) configured to be turned on when the battery is in the first voltage state, and turned off when the battery is in the second voltage state; and

a second switch (second contactor S/C_B and third contactor S/C_C) configured to be turned on when the battery is in the second voltage state, and turned off when the battery is in the first voltage state,

the switch drive mechanism includes a power supply (power supply 5) for driving the switch, and a switch drive circuit (switch drive circuit 6),

the switch drive circuit connects the power supply and a positive electrode of the first switch, connects a negative electrode of the first switch and a negative electrode of the second switch, and connects a positive electrode of the second switch and the power supply, and

the switch drive mechanism

when the battery is in the first voltage state, supplies the first switch with a current in a forward direction to turn on the first switch, and supplies the second switch with a current in a reverse direction to turn off the second switch, and

when the battery is in the second voltage state, supplies the second switch with a current in the forward direction to turn on the second switch, and supplies the first switch with a current in the reverse direction to turn off the first switch.

According to the above (1), when the battery is in the first voltage state, since a current in the forward direction is supplied to the first switch to turn on the first switch, and a current in the reverse direction is supplied to the second switch to turn off the second switch, a situation in which the second switch is unexpectedly turned on can be avoided. Further, when the battery is in the second voltage state, since a current in the forward direction is supplied to the second switch to turn on the second switch, and a current in the reverse direction is supplied to the first switch to turn off the first switch, a situation in which the first switch is unexpectedly turned on can be avoided. Accordingly, short-circuiting of the battery can be avoided.

(2) The battery system according to the above (1), in which

the switch drive mechanism includes:

a control unit (control unit 7) including the power supply, a first pin (first pin 71) connected to any one of a positive electrode (positive electrode 51) and a negative electrode (negative electrode 52) of the power supply, and a second pin (second pin 72) connected to an other one of the positive electrode and the negative electrode of the power supply, and

the switch drive circuit includes:

a first circuit (first series circuit 63) connecting the first pin and the positive electrode of the first switch;

a second circuit (second series circuit 64 and third series circuit 65) connecting the negative electrode of the first switch and the negative electrode of the second switch; and

a third circuit (fourth series circuit 66) connecting the positive electrode of the second switch and the second pin.

According to the above (2), it is possible to cause currents to flow through the first switch and the second switch at the same time by one control unit.

(3) The battery system according to the above (2), in which the control unit further includes a drive switch (first to fourth changeover switches 81 to 84) configured to switch between a first drive state in which a current supplied from the power supply is supplied from the first pin to the switch drive circuit and is returned from the switch drive circuit to the power supply through the second pin, and a second drive state in which a current supplied from the power supply is supplied from the second pin to the switch drive circuit and is returned from the switch drive circuit to the power supply through the first pin, and

the drive switch is set to the first drive state when the battery is in the first voltage state, and is set to the second drive state when the battery is in the second voltage state.

According to the above (3), switching between the first voltage state and the second voltage state of the battery can be realized by switching between the first drive state and the second drive state of the drive switch of the control unit.

(4) The battery system according to the above (3), in which the control unit includes first to fourth changeover switches (first to fourth changeover switches 81 to 84),

the first changeover switch (first changeover switch 81) is provided between the positive electrode of the power supply and the second pin,

the second changeover switch (second changeover switch 82) is provided between the positive electrode of the power supply and the first pin,

the third changeover switch (third changeover switch 83) is provided between the negative electrode of the power supply and the first pin,

the fourth changeover switch (fourth changeover switch 84) is provided between the negative electrode of the power supply and the second pin,

the first drive state is established when the first changeover switch and the third changeover switch are turned off and the second changeover switch and the fourth changeover switch are turned on, and

the second drive state is established when the first changeover switch and the third changeover switch are turned on and the second changeover switch and the fourth changeover switch are turned off.

According to the above (4), the switching between the first voltage state and the second voltage state of the battery can be realized by switching between the on state and the off state of each of the first to fourth changeover switches of the control unit.

(5) The battery system according to any one of (1) to (4), in which

the battery includes:

the first power storage unit;

the second power storage unit;

a positive node (positive node 23) connecting a positive terminal of the first power storage unit and a positive terminal of the second power storage unit in parallel;

a negative node (negative node 24) connecting a negative terminal of the first power storage unit and a negative terminal of the second power storage unit in parallel;

a connection circuit (connection circuit 25) connecting the negative terminal of the first power storage unit and the positive terminal of the second power storage unit;

a first contactor (first contactor S/C_A) provided in the connection circuit;

a second contactor (second contactor S/C_B) provided between the positive node and a first connection part (first connection part 26) that connects the positive terminal of the second power storage unit and the connection circuit; and

a third contactor (third contactor S/C_C) provided between the negative node and a second connection part (second connection part 27) that connects the negative terminal of the first power storage unit and the connection circuit,

the first switch is implemented by the first contactor, and

the second switch includes the second contactor and the third contactor.

According to the above (5), since the on state can be maintained by causing a current in the forward direction to flow through a coil of each of the contactors, and the off state can be maintained by causing a current in the reverse direction to flow through the coil of each of the contactors, the short-circuiting of the battery can be avoided with a simple configuration.

What is claimed is:

1. A battery system comprising:
a battery including:
a first power storage unit;
a second power storage unit; and
a switch configured to switch between a first voltage state in which the first power storage unit and the second power storage unit are connected in series and are chargeable at a first voltage, and a second voltage state in which the first power storage unit and the second power storage unit are connected in parallel and are chargeable at a second voltage; and
a switch drive mechanism configured to drive the switch, wherein
the switch includes:
a first switch configured to be turned on when the battery is in the first voltage state, and turned off when the battery is in the second voltage state; and
a second switch configured to be turned on when the battery is in the second voltage state, and turned off when the battery is in the first voltage state,
the switch drive mechanism includes a power supply for driving the switch, and a switch drive circuit,
the switch drive circuit connects the power supply and a positive electrode of the first switch, connects a negative electrode of the first switch and a negative electrode of the second switch, and connects a positive electrode of the second switch and the power supply, and
the switch drive mechanism
when the battery is in the first voltage state, supplies the first switch with a current in a forward direction to turn on the first switch, and supplies the second switch with a current in a reverse direction to turn off the second switch, and
when the battery is in the second voltage state, supplies the second switch with a current in the forward direction to turn on the second switch, and supplies the first switch with a current in the reverse direction to turn off the first switch.

2. The battery system according to claim 1, wherein
the switch drive mechanism includes:
a control unit including the power supply, a first pin connected to any one of a positive electrode and a negative electrode of the power supply, and a second pin connected to an other one of the positive electrode and the negative electrode of the power supply, and
the switch drive circuit includes:
a first circuit connecting the first pin and the positive electrode of the first switch;
a second circuit connecting the negative electrode of the first switch and the negative electrode of the second switch; and
a third circuit connecting the positive electrode of the second switch and the second pin.

3. The battery system according to claim 2, wherein
the control unit further includes a drive switch configured to switch between a first drive state in which a current supplied from the power supply is supplied from the first pin to the switch drive circuit and is returned from the switch drive circuit to the power supply through the second pin, and a second drive state in which a current supplied from the power supply is supplied from the second pin to the switch drive circuit and is returned from the switch drive circuit to the power supply through the first pin, and
the drive switch is set to the first drive state when the battery is in the first voltage state, and is set to the second drive state when the battery is in the second voltage state.

4. The battery system according to claim 3, wherein
the control unit includes first to fourth changeover switches,
the first changeover switch is provided between the positive electrode of the power supply and the second pin,
the second changeover switch is provided between the positive electrode of the power supply and the first pin,
the third changeover switch is provided between the negative electrode of the power supply and the first pin,
the fourth changeover switch is provided between the negative electrode of the power supply and the second pin,
the first drive state is established when the first changeover switch and the third changeover switch are turned off and the second changeover switch and the fourth changeover switch are turned on, and
the second drive state is established when the first changeover switch and the third changeover switch are turned on and the second changeover switch and the fourth changeover switch are turned off.

5. The battery system according to claim 1, wherein
the battery includes:
the first power storage unit;
the second power storage unit;
a positive node connecting a positive terminal of the first power storage unit and a positive terminal of the second power storage unit in parallel;
a negative node connecting a negative terminal of the first power storage unit and a negative terminal of the second power storage unit in parallel;
a connection circuit connecting the negative terminal of the first power storage unit and the positive terminal of the second power storage unit;
a first contactor provided in the connection circuit;
a second contactor provided between the positive node and a first connection part that connects the positive terminal of the second power storage unit and the connection circuit; and
a third contactor provided between the negative node and a second connection part that connects the negative terminal of the first power storage unit and the connection circuit,
the first switch is implemented by the first contactor, and
the second switch includes the second contactor and the third contactor.
